(19) United States
(12) Patent Application Publication
(10) Pub. No.: US 2022/0248750 A1
(43) Pub. Date: Aug. 11, 2022

(54) MAGNETIC ATTRACTION ELECTRONIC CIGARETTE

(71) Applicant: O-NET AUTOMATION TECHNOLOGY (SHENZHEN) LIMITED, Shenzhen (CN)

(72) Inventors: Bo ZHOU, Shenzhen (CN); Meiling GUO, Shenzhen (CN); Pengfei ZHANG, Shenzhen (CN); Huihua HUANG, Shenzhen (CN); Fei SHEN, Shenzhen (CN)

(73) Assignee: O-NET AUTOMATION TECHNOLOGY (SHENZHEN) LIMITED, Shenzhen (CN)

(21) Appl. No.: 17/613,508

(22) PCT Filed: Jan. 9, 2020
(86) PCT No.: PCT/CN2020/071212

§ 371 Date: Nov. 23, 2021

(51) Int. Cl. A24F 40/40; A24F 7/00; A24F 40/50; A24F 40/10; H01R 13/62

(52) U.S. Cl. CPC A24F 40/40; A24F 7/00; H01R 13/6205; A24F 40/10; A24F 40/50

(57) ABSTRACT

A magnetic attraction electronic cigarette includes a case, a power supply device and an atomization device, which are sequentially arranged in the case, and a mouthpiece fitted at a first end of the case and corresponding to the atomization device. The power supply device includes a positioning support and a power supply unit; the atomization device includes an atomization shell, an atomization unit, and an atomization base; an abutting end of the positioning support is provided with a first magnetic attraction unit, and the atomization base is provided with a second magnetic attraction unit; and the atomization base abuts with the positioning support by means of the magnetic attraction of the second magnetic attraction unit to the first magnetic attraction unit. In the magnetic attraction electronic cigarette of the present invention, abutting ends of the power supply device and the atomization device are each provided with a magnetic attraction unit, such that the two can be stably connected by means of magnetic attraction. The assembly is simple, and the heat dissipation effect of the atomization device is not affected.

### FIELD OF THE INVENTION

The present invention relates to the field of electronic cigarettes, and more particularly to a magnetic attraction electronic cigarette.

### DESCRIPTION OF THE RELATED ART

An electronic cigarette is generally made up of a power supply device and an atomization device. Connection between the atomization device and the power supply device generally includes the following types:

(1) Threading connection: the power supply device and the atomization device are connected through rotating threads to achieve connection between electrodes. Such a connection structure is more secured. However, when it needs to recharge the power supply device, the atomization device must be first removed before the charging can be made. Mounting and removing repeated for an extended period of time results in wearing of the threads, leading to instability of connection between the power supply device and the atomization device and thus failure of normal operation.

(2) Snap connection: the power supply device and the atomization device are provided with snap fasteners that mate each other and connection is achieved through snap fitting, this being easy to operate; however repeated inserting and removing multiple times would result in wearing of the snap fasteners, leading to instability of connection between the power supply device and the atomization device and thus failure of normal operation.

### SUMMARY OF THE INVENTION

The technical issue that the present invention is made to overcome is to provide a magnetic attraction electronic cigarette that realizes stable connection between an atomization device and a power supply device by means of magnetic attraction.

The technical solution that the present invention adopts to resolve the technical issue is to provide a magnetic attraction electronic cigarette, comprising a case, a power supply device and an atomization device that are sequentially arranged in the case in a lengthwise direction of the case; and a mouthpiece mounted to a first end of the case to correspond to the atomization device;

the power supply device comprising a positioning support and a power supply unit arranged on the positioning support; the atomization device comprising an atomization shell located between the mouthpiece and the positioning support, an atomization unit arranged in the atomization shell, and an atomization base fitted to an end portion of the atomization shell that faces the positioning support;

the positioning support having an abutting end that faces the atomization base and is provided with a first magnetic attraction unit, the atomization base being provided with a second magnetic attraction unit; the atomization base being connectable to the positioning support by means of magnetic attraction between the second magnetic attraction unit and the first magnetic attraction unit.

Preferably, the first magnetic attraction unit is formed of magnetic powder or ferrous powder and is formed on the abutting end of the positioning support by means of one-piece injection molding; or alternatively, the first magnetic attraction unit comprises a magnetic attraction member inlaid in the abutting end of the positioning support; and

the second magnetic attraction unit is formed of magnetic powder or ferrous powder and is formed on the atomization base by means of one-piece injection molding; or alternatively, the second magnetic attraction unit comprises a magnetic attraction member inlaid in the atomization base.

Preferably, the magnetic powder comprises oxide magnetic powder and/or metal magnetic powder.

Preferably, one end of the atomization shell that faces the mouthpiece is located outside the first end of the case, the mouthpiece being set on and covering the end of the atomization shell and connected to the first end of the case; a seal ring is arranged between the end of the atomization shell and an internal wall of the mouthpiece; the atomization shell and the mouthpiece are provided therebetween with a piece of mouthpiece cotton.

Preferably, the power supply unit comprises a control assembly that is disposed on the positioning support and adjacent to a second end of the case, an electric core disposed on the positioning support and arranged at one side of the control assembly, and a first electrode assembly arranged at one side of the electric core that is opposite to the control assembly and exposed outside the abutting end of the positioning support; and

the first electrode assembly comprises a control switch and two first electrodes electrically connected to the control switch, the first electrodes being contacting and in electrically conductive connection with second electrodes of the atomization unit.

Preferably, the power supply device further comprises an insulation base fitted to the abutting end of the positioning support and covering the first electrode assembly; the first electrodes have one end penetrating out of the insulation base.

Preferably, the positioning support comprises a positioning board extending in the lengthwise direction of the case and a side plate surrounding and connected to a circumference of the positioning board; the side plate delimits and defines an accommodation trough on the positioning board for receiving and accommodating the power supply unit; and

the second end of the case is made open to form an opening; the side plate on one end of the positioning support that corresponds to the opening is fitted in the opening to close the opening.

Preferably, the atomization device further comprises a liquid storage compartment arranged in an interior of the atomization shell and a gas conduction tube; the gas conduction tube has an end inserted into the atomization unit and an opposite end connected to one end of the atomization shell that is opposite to the positioning support, and the end is formed with a gas flow outlet opening in communication with an internal channel of the gas conduction tube; the liquid storage compartment is arranged on a periphery of the gas conduction tube and is separated therefrom; and

a gas flow inlet opening is formed in a side surface of the case and/or the mouthpiece; the atomization unit is provided with an atomization channel penetrating two opposite ends thereof; the gas flow inlet opening, the atomization channel, and the internal channel of the gas conduction tube are set in communication with the gas flow outlet opening sequentially.

Preferably, the atomization unit comprises a first atomization seat and a second atomization seat fitted to each other, an atomization assembly arranged in a lateral form between the first atomization seat and the second atomization seat, a third atomization seat fitted between the second atomization seat and the atomization base, and a second electrode assembly inserted into and mounted to the atomization base;

one end of the gas conduction tube is inserted into and connected to the first atomization seat; the atomization channel is arranged in the first atomization seat, the second atomization seat, and the third atomization seat and penetrates through the atomization base; the atomization assembly is located in the atomization channel and has two opposite ends that are each in connection with the liquid storage compartment in a liquid conducting fashion; and

the second electrode assembly comprises two second electrodes, the second electrodes being in electrically conductive connection with the atomization assembly and the first electrodes of the power supply unit.

Preferably, the atomization base comprises a bottom plate fitted to an end portion of the atomization shell and a circumferential wall perpendicularly connected to a surface of the bottom plate and in tight fitting engagement with an internal wall of the atomization shell;

the third atomization seat has a first end fitted in a trough delimited and defined by the circumferential wall, the third atomization seat having an opposite second end that is in tight fitting with the internal wall of the atomization shell; the second electrodes have one end mounted, through insertion, to the bottom plate and an opposite end penetrating into the third atomization seat: and

the second end of the third atomization seat is formed with a positioning trough; the second atomization seat has a first end received in and positioned by the positioning trough and an opposite second end connected to the first atomization seat.

The magnetic attraction electronic cigarette according to the present invention is such that abutting ends of the power supply device and the atomization device are each provided with a magnetic attraction structure, and the two are stably connected by means of magnetic attraction. The assembly is easy and heat dissipation effect of the atomization device is not affected.

The magnetic attraction structure can be embedded in the abutting end of the power supply device or the atomization device through one-piece injection molding of magnetic powder or ferrous powder, so that inclusion of extra structural components can be reduced.

### BRIEF DESCRIPTION OF THE DRAWINGS

A detailed description of the present invention will be provided below with reference to the attached drawings and embodiments. In the drawings:

FIG. 1 is a cross-sectional view showing a structure of a magnetic attraction electronic cigarette according to a first embodiment of the present invention;

FIG. 2 is an exploded view showing the magnetic attraction electronic cigarette according to the first embodiment of the present invention;

FIG. 3 is a cross-sectional view showing a structure of a magnetic attraction electronic cigarette according to a second embodiment of the present invention;

FIG. 4 is a cross-sectional view showing a structure of a magnetic attraction electronic cigarette according to a third embodiment of the present invention; and

FIG. 5 is a cross-sectional view showing a structure of a magnetic attraction electronic cigarette according to a fourth embodiment of the present invention.

### DETAILED DESCRIPTION OF PREFERRED EMBODIMENTS OF THE INVENTION

For better understanding of the technical features, purposes, and efficacy of the present invention, embodiments of the present invention will be described in detail with reference to the drawings.

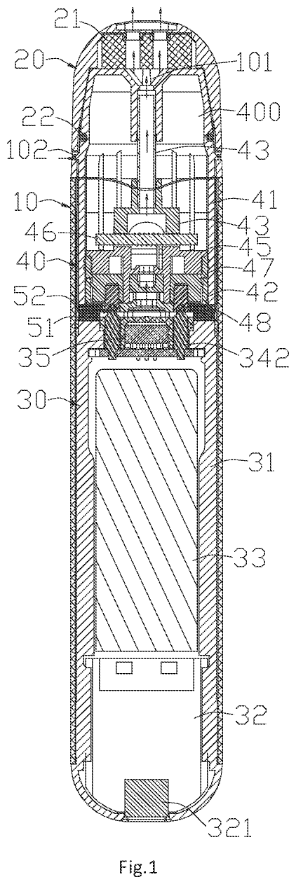

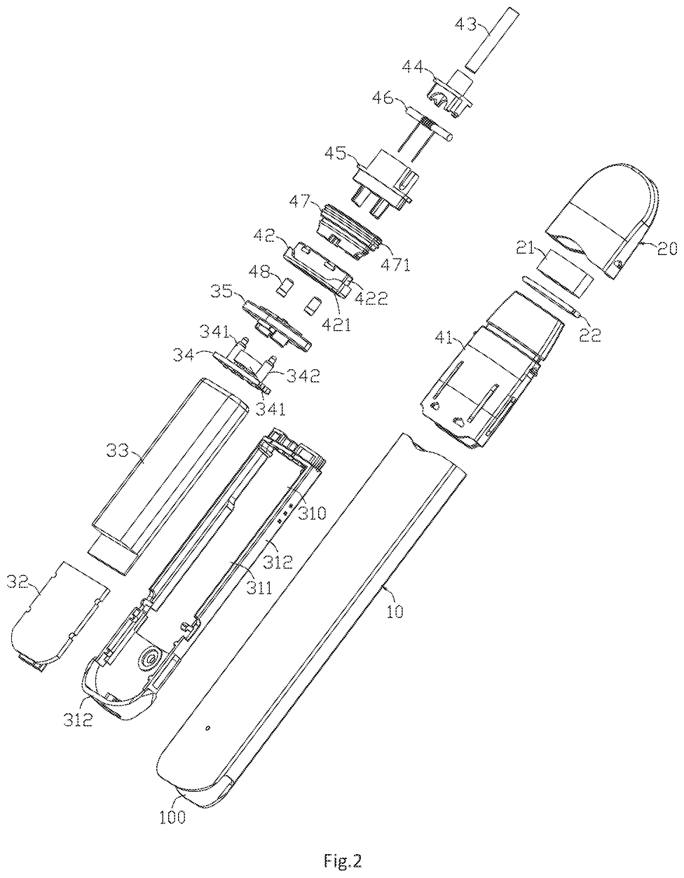

As shown in FIGS. 1 and 2, a magnetic attraction electronic cigarette according to a first embodiment of the present invention comprises a case 10; a power supply device 30 and an atomization device 40 that are sequentially arranged in the case 10 in a lengthwise direction of the case 10; and a mouthpiece 20 mounted to a first end of the case 10 to correspond to the atomization device 40.

The case 10 comprises a first end and a second end that are opposite to each other. The power supply device 30 and the atomization device 40 are respectively disposed in the second end and the first end of the case 10. The first end is an open end, and the mouthpiece 20 is mounted to the first end to close the first end. The power supply device 30 is connected to the atomization device 40 to supply electricity to the atomization device 40.

The power supply device 30 comprises a positioning support 31 and a power supply unit arranged on the positioning support 31. The atomization device 40 comprises an atomization shell 41 located between the mouthpiece 20 and the positioning support 31, an atomization unit arranged in the atomization shell 41, and an atomization base 42 fitted to an end portion of the atomization shell 41 that faces the positioning support 31.

The positioning support 31 has an abutting end that faces the atomization base 42 and is provided with a first magnetic attraction unit 51. The atomization base 42 is provided with a second magnetic attraction unit 52. The first magnetic attraction unit 51 and the second magnetic attraction unit 52 are set in contact with each other by means of magnetic attraction, so that the atomization base 42 is connected to the positioning support 31 by means of the magnetic attraction between the second magnetic attraction unit 52 and the first magnetic attraction unit 51 to thereby realize abutting connection between the power supply device 30 and the atomization device 40.

In the instant embodiment, the first magnetic attraction unit 51 is mainly formed of magnetic powder or ferrous powder and may be integrally formed on the abutting end of the positioning support 31 by means of one-piece injection molding, with a distribution range determined according by a desired connecting area between the abutting end and the atomization base 42. The second magnetic attraction unit 52 is also formed of magnetic powder or ferrous powder and may be integrally formed on the atomization base 42 by means of one-piece injection molding, with a distribution range determined according to a desired connecting area thereof with the positioning support 31. The first magnetic attraction unit 51 and the second magnetic attraction unit 52 of the instant embodiment are each formed of solid powder spread on a corresponding part, so that no additional component is needed and no additional assembly operation is required. In assembly, the atomization base 42 is moved to approach the positioning support 31 to allow the two to abut each other and connect to each other by means of combination achieved with magnetic attraction.

In case that the first magnetic attraction unit 51 is formed of magnetic powder, the second magnetic attraction unit 52 may select to comprise magnetic powder or ferrous powder; and in case that the first magnetic attraction unit 51 is formed of ferrous powder, the second magnetic attraction unit 52 may select to comprise magnetic powder. In other words, at least one of the two must be formed of magnetic powder. The magnetic powder may comprise oxide magnetic powder and/or metal magnetic powder, in which the oxide magnetic powder includes one or multiple ones of iron oxide magnetic powder, chromium dioxide magnetic powder, and cobalt-iron oxide magnetic powder.

Specifically, in the present invention, the case 10 can be a cylindrical case, or can be, as shown in FIG. 2, a flat case. The mouthpiece 20 is arranged to correspond to the case 10, and is combinable with the case 10 to form, together with the case 10, a complete case for the entirety of the electronic cigarette.

The power supply device 30 is disposed in the second end of the case 10, with the positioning support 31 thereof being corresponding to and arranged in an internal space of the second end of the case 10. Optionally, the positioning support 31 comprises a positioning board 311 extending in the lengthwise direction of the case 10 and a side plate 312 surrounding and connected to a circumference of the positioning board 311. The side plate 312 delimits and defines an accommodation trough 310 on the positioning board 311 for receiving and accommodating the power supply unit.

To make assembly easy, the second end of the case 10 can be made open and forming an opening 100, so that the power supply device 30 may move, through the opening 100, into the case 10. The side plate 312 located at an end of the positioning support 31 that corresponds to the opening 100 is fit into the opening 100 for closure thereof.

The power supply unit of the power supply device 30 is received and accommodated in the accommodation trough 310 of the positioning support 31, and is positioned, by means of the positioning support 31, at a corresponding location inside the case 10. The power supply unit comprises a control assembly 32, an electric core 33, and a first electrode assembly 34. The control assembly 32 is arranged on the positioning support 31 and adjacent to the second end of the case 10. The electric core 33 is arranged on the positioning support 31 to be located at one side of the control assembly 32 that faces the atomization device 40. The first electrode assembly 34 is arranged at one side of the electric core 33 that is opposite to the control assembly 32 and is exposed outside the abutting end of the positioning support 31. The control assembly 32, the electric core 33, and the first electrode assembly 34 are electrically connected by means of conductive wires. One end of the control assembly 32 may be provided with a charging port 321 that is exposed outside one end of the positioning support 31 that is opposite to the atomization device 40, so that the charging port 321 is connectable with an electric main for electrical charging of the electric core.

The first electrode assembly 34 comprises a control switch 341 and two first electrodes 342 electrically connected to the control switch 341. The first electrodes 342 are in contact engagement with second electrodes 48 of the atomization unit for electrical connection therebetween. The control switch 341 is preferably a gas-flow switch. The two first electrodes 342 respectively correspond to a positive electrode and a negative electrode.

Further, the power supply device 30 may comprise an insulation base 35, which is mounted to the abutting end of the positioning support 31 and is set on and covers the first electrode assembly 34. One end of the first electrodes 342 penetrates through and extends outside the insulation base 35 to contact and connect with the second electrodes 48. The insulation base 35 is made of a material including silicone rubber exhibiting an insulative property and also possessing a property of elasticity, so as to be securely positioning on the positioning support 31 and enhancing fixing of the first electrode assembly 34 on the positioning support 31.

The atomization device 40 is disposed in the first end of the case 10, and may be entirely located in an interior of the first end. Or alternatively, one end of the atomization shell 41 that faces the mouthpiece 20 is located outside the first end of the case 10. The mouthpiece 20 caps and closes said one end of the atomization shell 41 and is combinable with the first end of the case 10 by means of snap fastening, so as to house the atomization device 40 inside the case 10. The end of the atomization shell 41 that faces the mouthpiece 20 and an internal wall of the mouthpiece 20 are provided therebetween with a seal ring to realize sealing between the two.

In the atomization device 40, one end of the atomization shell 41 that faces the power supply device 30 is made open, and the atomization base 42 is arranged at said end to close the end. The atomization unit is received and accommodated in the atomization shell 41 and is fitted to the atomization base 42. Another end of the atomization shell 41 that is on an opposite side faces the mouthpiece 20, and the end is provided with a gas flow outlet opening connected to and in communication with a mouthpiece opening of the mouthpiece 20. The atomization shell 41 and the mouthpiece 20 are provided therebetween with a piece of mouthpiece cotton 21 for adsorbing condensed cigarette liquid and preventing condensed cigarette liquid from draining into human mouth during vaping of the electronic cigarette.

The atomization device 40 further comprises a liquid storage compartment 400 formed in an interior of the atomization shell 41 and a gas conduction tube 43. The gas conduction tube 43 has an axial direction that is parallel to the lengthwise direction of the atomization shell 41. The gas conduction tube 43 has one end that is inserted into and mounted to the atomization unit and an opposite end that is connected to the end of the atomization shell 41 that is opposite to the positioning support 31. The gas conduction tube 43 has an internal channel that is in communication with a gas flow outlet opening 101 of the atomization shell 41. The liquid storage compartment 400 is located on an outer periphery of the gas conduction tube 43 and is separated from the internal channel of the gas conduction tube.

A gas flow inlet opening 102 is formed in a side surface of the case 10 and/or the mouthpiece 20. The atomization unit is provided with an atomization channel penetrating through two opposite ends thereof. The gas flow inlet opening 102, the atomization channel, the internal channel of the gas conduction tube 43 are set to be in communication with the gas flow outlet opening 101 sequentially so as to form a gas flow passage, in which a gas flow moves in a direction indicated by arrows shown in FIG. 1. The gas flow inlet opening 102 is set in communication with the atomization channel through a gap between the case 10 and the atomization shell 41.

The atomization unit may comprise a first atomization seat 44, a second atomization seat 45, an atomization assembly 46, a third atomization seat 47, and a second electrode assembly. The first atomization seat 44 and the second atomization seat 45 are fitted to each other. The atomization assembly 46 is arranged, in a lateral form, between the first atomization seat 44 and the second atomization seat 45. The third atomization seat 47 is fitted between the second atomization seat 45 and the atomization base 42. The second electrode assembly is inserted into and mounted to the atomization base 47 to get contact with and electrically connect with the first electrodes 342 of the power supply device 30.

One end of the gas conduction tube 43 is inserted into and connected to the first atomization seat 44, and the liquid storage compartment 400 is formed between the gas conduction tube 43, the atomization shell 41 and the atomization unit. The atomization channel is arranged in the first atomization seat 44, the second atomization seat 45, and the third atomization seat 47 and penetrates through the atomization base 42. The atomization assembly 46 is located in the atomization channel and has two opposite ends that are each in connection with the liquid storage compartment 400 in a liquid conducting fashion.

The atomization assembly 46 comprises a piece of liquid conducting cotton and a heating filament wound around and covering the liquid conducting cotton. The heating filament is primarily wound around and covering an axial section of the liquid conducting cotton that is located in the atomization channel, whereas two ends of the liquid conducting cotton extend outside the first atomization seat 44 and the second atomization seat 45 to penetrate into the storage compartment 400 for absorbing cigarette liquid.

The second electrode assembly comprises the two second electrodes 48, which respectively correspond to a positive electrode and a negative electrode. The second electrodes 48 are in electrically conductive connection with the atomization assembly 46 and the first electrodes 342 of the power supply unit. The first electrodes 342 may be elastic electrode to achieve, inside the electronic cigarette, constantly effective contact thereof with the second electrodes 48.

Specifically, in the atomization device 40, the atomization base 42 may comprises a bottom plate 421 and a circumferential wall 422 perpendicularly connected to a surface of the bottom plate 421. The atomization base 42 is fitted, by means of the bottom plate 421 thereof, to an end portion of the atomization shell 41, and the circumferential wall 422 extends into the atomization shell 41 to form tight fitting with an internal wall of the atomization shell 41, so as to have the atomization base 42 tightly and securely fix to the atomization shell 41.

The third atomization seat 47, the second atomization seat 45, and the first atomization seat 44 are sequentially arranged on the atomization base 42 inside the atomization shell 41. The third atomization seat 47 comprises a first end and a second end that are opposite to each other, and the first end is fitted inside a trough delimited and defined by the circumferential wall 422. The second end of the third atomization seat 47 is set in tight fitting engagement with an internal wall of the atomization shell 41. The second end of the third atomization seat 47 has a circumferential surface that is further provided with at least one reinforcement rib 471 in abutting contact engagement with the internal wall of the atomization shell 41.

The second electrodes 48 have one end mounted, through insertion, on the bottom plate 421 of the atomization base 42, such that a tip thereof exposed outside a lower surface of the bottom plate 421 that faces the power supply device 30 for contacting and connecting with the first electrodes 342. The second electrodes 48 have an opposite end penetrating into one end of the third atomization seat 47 to connect with conductive wiring and to connect, through the conductive wiring, to the atomization assembly 46.

The second end of the third atomization seat 47 is provided with a positioning trough. The second atomization seat 45 has a first end that is received in and positioned by the positioning trough and an opposite second end connected with the first atomization seat 44.

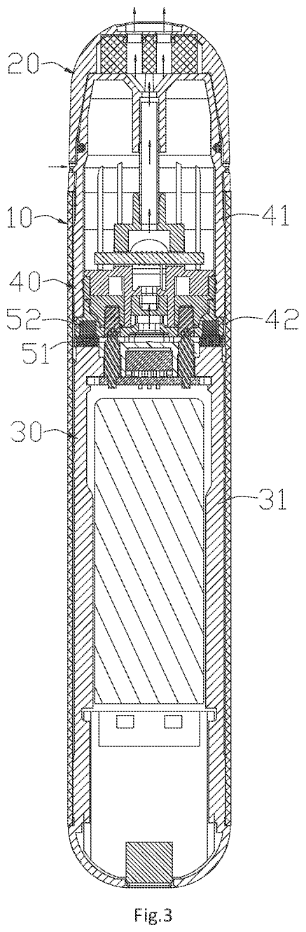

As shown in FIG. 3, a magnetic attraction electronic cigarette according to a second embodiment of the present invention comprises a case 10; a power supply device 30 and a atomization device 40 that are sequentially arranged in the case 10 in a lengthwise direction of the case 10; and a mouthpiece 20 mounted to a first end of the case 10 to correspond to the atomization device 40.

The case 10 comprises a first end and a second end that are opposite to each other. The power supply device 30 and the atomization device 40 are respectively disposed in the second end and the first end of the case 10. The first end is an open end, and the mouthpiece 20 is mounted to the end to close the end. The power supply device 30 is connected to the atomization device 40 to supply electricity to the atomization device 40.

The power supply device 30 comprises a positioning support 31 and a power supply unit arranged on the positioning support 31. The atomization device 40 comprises an atomization shell 41 located between the mouthpiece 20 and the positioning support 31, an atomization unit arranged in the atomization shell 41, and an atomization base 42 fitted to an end portion of the atomization shell 41 that faces the positioning support 31.

The positioning support 31 has an abutting end that faces the atomization base 42 and is provided with a first magnetic attraction unit 51. The atomization base 42 is provided with a second magnetic attraction unit 52. The first magnetic attraction unit 51 and the second magnetic attraction unit 52 are set in contact with each other by means of magnetic attraction, so that the atomization base 42 is connected to the positioning support 31 by means of the magnetic attraction between the second magnetic attraction unit 52 and the first magnetic attraction unit 51 to thereby realizing abutting connection between the power supply device 30 and the atomization device 40.

In the instant embodiment, the first magnetic attraction unit 51 is mainly formed of magnetic powder or ferrous powder and is formed on the abutting end of the positioning support 31 by means of one-piece injection molding, with a distribution range determined according by a desired connecting area between the abutting end and the atomization base 42. The second magnetic attraction unit 52 comprises an magnetic attraction member inlaid in the abutting end of the atomization base 42. The magnetic attraction member may comprise a ferrous block or a magnet block.

In case that the first magnetic attraction unit 51 is formed of magnetic powder, the second magnetic attraction unit 52 may select to comprise a ferrous block or a magnet block; and in case that the first magnetic attraction unit 51 is formed of ferrous powder, the second magnetic attraction unit 52 may select to comprise a magnet block. The magnetic powder comprises oxide magnetic powder and/or metal magnetic powder, in which the oxide magnetic powder includes one or multiple ones of iron oxide magnetic powder, chromium dioxide magnetic powder, and cobalt-iron oxide magnetic powder. The magnet block can be an oxide magnet block and/or a metal magnet block.

In the instant embodiment, structures of the case 10, the mouthpiece 20, the power supply device 30, and the atomization device 40 may refer to those of the first embodiment described above, and repeated description will be omitted herein.

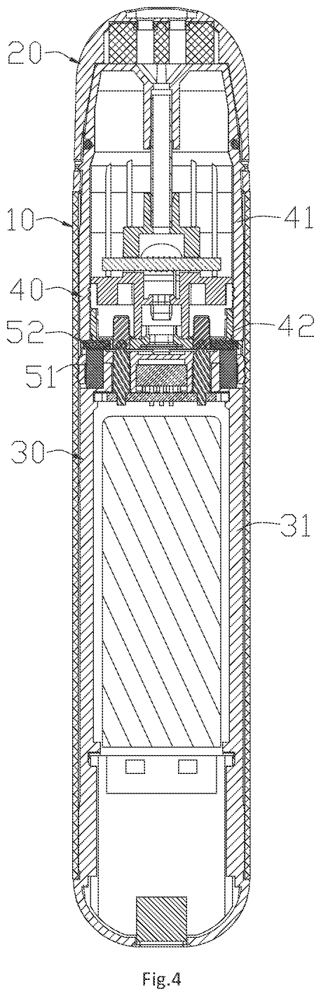

As shown in FIG. 4, a magnetic attraction electronic cigarette according to a third embodiment of the present invention comprises a case 10; a power supply device 30 and an atomization device 40 that are sequentially arranged in the case 10 in a lengthwise direction of the case 10; and a mouthpiece 20 mounted to a first end of the case 10 to correspond to the atomization device 40.

The case 10 comprises a first end and a second end that are opposite to each other. The power supply device 30 and the atomization device 40 are respectively disposed in the second end and the first end of the case 10. The first end is an open end, and the mouthpiece 20 is mounted to the end to close the end. The power supply device 30 is connected to the atomization device 40 to supply electricity to the atomization device 40.

The power supply device 30 comprises a positioning support 31 and a power supply unit arranged on the positioning support 31. The atomization device 40 comprises an atomization shell 41 located between the mouthpiece 20 and the positioning support 31, an atomization unit arranged in the atomization shell 41, and an atomization base 42 fitted to an end portion of the atomization shell 41 that faces the positioning support 31.

The positioning support 31 has an abutting end that faces the atomization base 42 and is provided with a first magnetic attraction unit 51. The atomization base 42 is provided with a second magnetic attraction unit 52. The first magnetic attraction unit 51 and the second magnetic attraction unit 52 are set in contact with each other by means of magnetic attraction, so that the atomization base 42 is connected to the positioning support 31 by means of the magnetic attraction between the second magnetic attraction unit 52 and the first magnetic attraction unit 51 to thereby realizing abutting connection between the power supply device 30 and the atomization device 40.

In the instant embodiment, the first magnetic attraction unit 51 comprises a magnetic attraction member inlaid in the abutting end of the positioning support 31. The magnetic attraction member may comprise a ferrous block or a magnet block. The second magnetic attraction unit 52 is mainly formed of magnetic powder or the ferrous powder and is formed on the abutting end of the atomization base 42 by means of one-piece injection molding, with a distribution range determined according to a desired connecting area between the abutting end and the positioning support 31.

In case that the first magnetic attraction unit 51 is formed of a ferrous block, the second magnetic attraction unit 52 may select to be formed of magnetic powder; and in case that the first magnetic attraction unit 51 comprises a magnet block, the second magnetic attraction unit 52 may select to be formed of ferrous powder or magnetic powder. The magnetic powder comprises oxide magnetic powder and/or metal magnetic powder, in which the oxide magnetic powder includes one or multiple ones of iron oxide magnetic powder, chromium dioxide magnetic powder, and cobalt-iron oxide magnetic powder.

In the instant embodiment, structures of the case 10, the mouthpiece 20, the power supply device 30, and the atomization device 40 may refer to those of the first embodiment described above, and repeated description will be omitted herein.

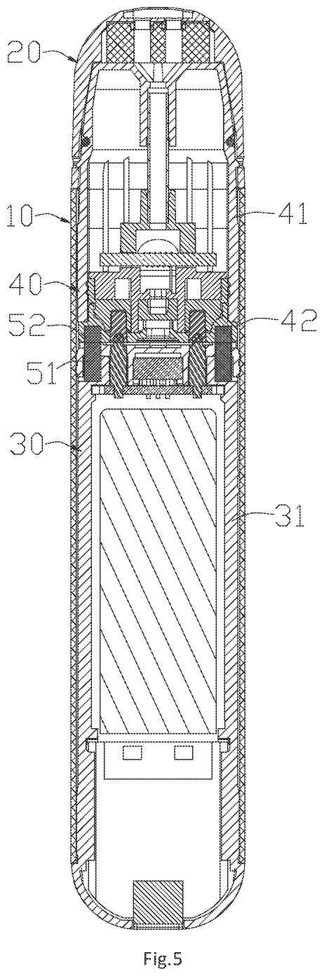

As shown in FIG. 5, a magnetic attraction electronic cigarette according to a fourth embodiment of the present invention comprises a case 10; a power supply device 30 and an atomization device 40 that are sequentially arranged in the case 10 in a lengthwise direction of the case 10; and a mouthpiece 20 mounted to a first end of the case 10 to correspond to the atomization device 40.

The case 10 comprises a first end and a second end that are opposite to each other. The power supply device 30 and the atomization device 40 are respectively disposed in the second end and the first end of the case 10. The first end is an open end, and the mouthpiece 20 is mounted to the end to close the end. The power supply device 30 is connected to the atomization device 40 to supply electricity to the atomization device 40.

The power supply device 30 comprises a positioning support 31 and a power supply unit arranged on the positioning support 31. The atomization device 40 comprises an atomization shell 41 located between the mouthpiece 20 and the positioning support 31, an atomization unit arranged in the atomization shell 41, and an atomization base 42 fitted to an end portion of the atomization shell 41 that faces the positioning support 31.

The positioning support 31 has an abutting end that faces the atomization base 42 and is provided with a first magnetic attraction unit 51. The atomization base 42 is provided with a second magnetic attraction unit 52. The first magnetic attraction unit 51 and the second magnetic attraction unit 52 are set in contact with each other by means of magnetic attraction, so that the atomization base 42 is connected to the positioning support 31 by means of the magnetic attraction between the second magnetic attraction unit 52 and the first magnetic attraction unit 51 to thereby realizing abutting connection between the power supply device 30 and the atomization device 40.

In the instant embodiment, the first magnetic attraction unit 51 comprises a magnetic attraction member inlaid in the abutting end of the positioning support 31. The magnetic attraction member may comprise a ferrous block or a magnet block. The second magnetic attraction unit 52 comprises a magnetic attraction member inlaid in an abutting end of the atomization base 42. The magnetic attraction member may comprise a ferrous block or a magnet block.

In case that the first magnetic attraction unit 51 comprises a ferrous block, the second magnetic attraction unit 52 may select to comprise a magnet block: and in case that the first magnetic attraction unit 51 comprises a magnet block, the second magnetic attraction unit 52 may be a ferrous block or a magnet block.

In the instant embodiment, structures of the case 10, the mouthpiece 20, the power supply device 30, and the atomization device 40 may refer to those of the first embodiment described above, and repeated description will be omitted herein.

The magnetic attraction electronic cigarette according to the present invention is such that the power supply device 30 is first put into the case 10, and then, the atomization device 40 is introduced into the case 10 to combine with the power supply device 30 by means of magnetic attraction, and finally, the mouthpiece 20 is put on and covers the case 10 to encase the atomization device 40 and the power supply device 30 inside the case 10. The operation is easy and efficient.

The description provided above relates to only some embodiments of the present invention and is not intended to limit the scope of the claims of the invention. Equivalent structures or equivalent conversions of process that are made according to the contents of the disclosure and attached drawings or are directly or indirectly used in related technical fields are similarly included in the scope of the claims of the invention.

1. A magnetic attraction electronic cigarette, comprising a case, a power supply device and an atomization device that are sequentially arranged in the case in a lengthwise direction of the case; and a mouthpiece mounted to a first end of the case to correspond to the atomization device;
the power supply device comprising a positioning support and a power supply unit arranged on the positioning support; the atomization device comprising an atomization shell located between the mouthpiece and the positioning support, an atomization unit arranged in the atomization shell, and an atomization base fitted to an end portion of the atomization shell that faces the positioning support; and
the positioning support having an abutting end that faces the atomization base and is provided with a first magnetic attraction unit, the atomization base being provided with a second magnetic attraction unit; the atomization base being connectable to the positioning support by means of magnetic attraction between the second magnetic attraction unit and the first magnetic attraction unit.

2. The magnetic attraction electronic cigarette according to claim 1, wherein the first magnetic attraction unit is formed of magnetic powder or ferrous powder and is integrally formed on the abutting end of the positioning support by means of one-piece injection molding; and
the second magnetic attraction unit is formed of magnetic powder or ferrous powder and is integrally formed on the atomization base by means of one-piece injection molding.

3. The magnetic attraction electronic cigarette according to claim 2, wherein the magnetic powder comprises oxide magnetic powder and/or metal magnetic powder.

4. The magnetic attraction electronic cigarette according to claim 1, wherein an end of the atomization shell that faces the mouthpiece is located outside the first end of the case, the mouthpiece being set on and covering the end of the atomization shell and connected to the first end of the case; a seal ring is arranged between the end of the atomization shell and an internal wall of the mouthpiece; the atomization shell and the mouthpiece are provided therebetween with a piece of mouthpiece cotton.

5. The magnetic attraction electronic cigarette according to claim 1, wherein the power supply unit comprises a control assembly that is disposed on the positioning support and adjacent to a second end of the case, an electric core disposed on the positioning support and arranged at one side of the control assembly, and a first electrode assembly arranged at one side of the electric core that is opposite to the control assembly and exposed outside the abutting end of the positioning support; and
the first electrode assembly comprises a control switch and two first electrodes electrically connected to the control switch, the first electrodes being contacting and in electrically conductive connection with second electrodes of the atomization unit.

6. The magnetic attraction electronic cigarette according to claim 5, wherein the power supply device further comprises an insulation base fitted to the abutting end of the positioning support and covering the first electrode assembly; the first electrodes have one end penetrating out of the insulation base.

7. The magnetic attraction electronic cigarette according to claim 5, wherein the positioning support comprises a positioning board extending in the lengthwise direction of the case and a side plate surrounding and connected to a circumference of the positioning board; the side plate delimits and defines an accommodation trough on the positioning board for receiving and accommodating the power supply unit; and
the second end of the case is made open to form an opening; the side plate on one end of the positioning support that corresponds to the opening is fitted in the opening to close the opening.

8. The magnetic attraction electronic cigarette according to claim 1, wherein the atomization device further comprises a liquid storage compartment arranged in an interior of the atomization shell and a gas conduction tube; the gas conduction tube has an end inserted into the atomization unit and an opposite end connected to an end of the atomization shell that is opposite to the positioning support and is formed with a gas flow outlet opening in communication with an internal channel of the gas conduction tube; the liquid storage compartment is arranged on a periphery of the gas conduction tube and is separated therefrom; and
a gas flow inlet opening is formed in a side surface of the case and/or the mouthpiece; the atomization unit is provided with an atomization channel penetrating two opposite ends thereof; the gas flow inlet opening, the atomization channel, and the internal channel of the gas conduction tube are set in communication with the gas flow outlet opening sequentially.

9. The magnetic attraction electronic cigarette according to claim 8, wherein the atomization unit comprises a first atomization seat and a second atomization seat fitted to each other, an atomization assembly arranged in a lateral form between the first atomization seat and the second atomization seat, a third atomization seat fitted between the second atomization seat and the atomization base, and a second electrode assembly inserted into and mounted to the atomization base;
the end of the gas conduction tube is inserted into and connected to the first atomization seat; the atomization channel is arranged in the first atomization seat, the second atomization seat, and the third atomization seat and penetrates through the atomization base; the atomization assembly is located in the atomization channel and has two opposite ends that are each in connection with the liquid storage compartment in a liquid conducting fashion; and
the second electrode assembly comprises two second electrodes, the second electrodes being in electrically conductive connection with the atomization assembly and the first electrodes of the power supply unit.

10. The magnetic attraction electronic cigarette according to claim 8, wherein the atomization base comprises a bottom plate fitted to the end portion of the atomization shell and a circumferential wall perpendicularly connected to a surface of the bottom plate and in tight fitting engagement with an internal wall of the atomization shell;
the third atomization seat has a first end fitted in a trough delimited and defined by the circumferential wall, the third atomization seat having an opposite second end that is in tight fitting with the internal wall of the atomization shell; the second electrodes have one end mounted, through insertion, to the bottom plate and an opposite end penetrating into the third atomization seat; and
the second end of the third atomization seat is formed with a positioning trough; the second atomization seat has a first end received in and positioned by the positioning trough and an opposite second end connected to the first atomization seat.

11. The magnetic attraction electronic cigarette according to claim 1, wherein the first magnetic attraction unit is a magnetic attraction member inlaid in the abutting end of the positioning support.

12. The magnetic attraction electronic cigarette according to claim 1, wherein the second magnetic attraction unit is a magnetic attraction member inlaid in the atomization base.
